(19) United States
(12) Patent Application Publication
(10) Pub. No.: US 2021/0271267 A1
(43) Pub. Date: Sep. 2, 2021

(54) SYSTEM FOR COMPENSATING AERIAL VEHICLE ATTITUDE DISTURBANCES

(71) Applicant: Exyn Technologies, Philadelphia, PA (US)

(72) Inventor: Justin Thomas, Philadelphia, PA (US)

(21) Appl. No.: 16/805,765

(22) Filed: Feb. 29, 2020

(51) Int. Cl. G05D 1/08; G05D 1/00; B64C 29/00; B64C 39/02

(52) U.S. Cl. CPC G05D 1/0858; G05D 1/0094; B64C 2201/162; B64C 39/024; B64C 2201/108; B64C 29/0025

(57) ABSTRACT

A method for compensating disturbances in an aerial vehicle having a plurality of thrusters, the disturbances caused by a payload rotating about one or more axes and coupled to the aerial vehicle, the method including the steps of determining aerial vehicle parameters; determining payload parameters comprising physical parameters and dynamic parameters; determining a preferred orientation of the aerial vehicle based on the aerial vehicle parameters and operational instructions; determining a corrective input based on aerial vehicle parameters, payload parameters, and actual orientation feedback; determining an operation of one or more of the plurality of thrusters based on the corrective input and the preferred orientation, then controlling an output of one or more of the plurality of thrusters accordingly; and determining an actual orientation of the aerial vehicle and generating the actual orientation feedback.

### BACKGROUND

Aerial vehicles, such as unmanned aerial vehicles (UAV), perform many useful operations, including surveillance, reconnaissance, and exploration tasks for military and civilian applications. Such vehicles may carry a payload configured to perform one or more specific functions.

Many UAVs are equipped with an onboard attitude control system thereby enabling the drone to maintain a stable attitude relative to the ground or some other object, without constant user input. Typical attitude control methods may be less effective when the UAV carries payloads that impart an oscillating attitude disturbance upon the UAV.

Because attitude control methods generally involve measuring the UAV's present attitude relative to the desired attitude then implementing an appropriate correction response, such methods may be less effective when an onboard payload imparts a noncontinuous, or continuous and oscillating attitude disturbance upon the UAV, such as imparted by a rotating LiDAR system. As the attitude disturbance caused by the payload's rotation progresses through its oscillation period, the attitude control system may lag behind the disturbance and may be less able to sufficiently compensate for the disturbance. In such a reactive state, the attitude control system must wait until the disturbance manifests itself in an attitude deviation from the preferred attitude before issuing corrective instructions. By the time the attitude control loop implements a correction, the attitude disturbance has progressed to a different phase in its oscillation, thereby imparting a new and different disturbance from the one corrected by the attitude control system. For some configurations, the attitude control system may lag behind the oscillatory disturbance causing the UAV to wobble in a manner that may be detrimental to the UAV's intended application.

A system wherein the oscillating disturbance is analyzed and modeled prior to, or during flight may allow corrective instructions to be imparted in-flight upon the UAV in phase with the oscillating disturbance thereby addressing and minimizing attitude deviation before it occurs.

Such a system may be significantly more beneficial for applications involving multi-axis oscillating disturbances, such as those caused by payloads with components that spin about one or more axes relative to the UAV SUMMARY OF DISCLOSURE

A method for compensating disturbances in an aerial vehicle having a plurality of thrusters, the disturbances caused by a payload rotating about one or more axes and coupled to the aerial vehicle, the method including the steps of determining aerial vehicle parameters; determining payload parameters comprising physical parameters and dynamic parameters; determining a preferred orientation of the aerial vehicle based on the aerial vehicle parameters and operational instructions; determining a corrective input based on aerial vehicle parameters, payload parameters, and actual orientation feedback; determining an operation of one or more of the plurality of thrusters based on the corrective input and the preferred orientation, then controlling an output of one or more of the plurality of thrusters accordingly; and determining an actual orientation of the aerial vehicle and generating the actual orientation feedback.

### BRIEF DESCRIPTION OF THE DRAWINGS

The detailed description is set forth with reference to the accompanying drawings, which are not necessarily drawn to scale. The use of the same reference numbers in different figures indicate similar or identical terms.

FIG. 1 shows a flowchart for a method for maintaining aircraft attitude according to related art.

FIG. 2A shows a perspective view of an unmanned aerial vehicle according to an aspect of the present disclosure.

FIG. 2B shows a side view of the system with a dynamic payload according to an aspect of the present disclosure.

FIG. 2C shows a perspective view of the system with a dynamic payload according to an aspect of the present disclosure.

FIG. 3A shows a perspective view of the system according to an aspect of the present disclosure.

FIG. 3B shows a perspective view of the system according to an aspect of the present disclosure.

FIG. 4 shows a flowchart for a method for maintaining aircraft attitude according to an aspect of the present disclosure.

FIG. 5 shows a data flow diagram of a system according to an aspect of the present disclosure.

FIGS. 6A-6D show physical characteristics that may be considered for one or more physical parameters of an aircraft, in accordance with an aspect of the present disclosure.

FIG. 7 shows an internal perspective view of an unmanned aerial drone payload according to an aspect of the present disclosure.

FIGS. 8A, 8B, and 8C show a system without compensation.

FIGS. 9A and 9B show a system with compensation according to an aspect of the present disclosure.

FIG. 10 shows graphs illustrating vehicle angular velocity versus gimbal angle according to an aspect of the present disclosure.

### DETAILED DESCRIPTION

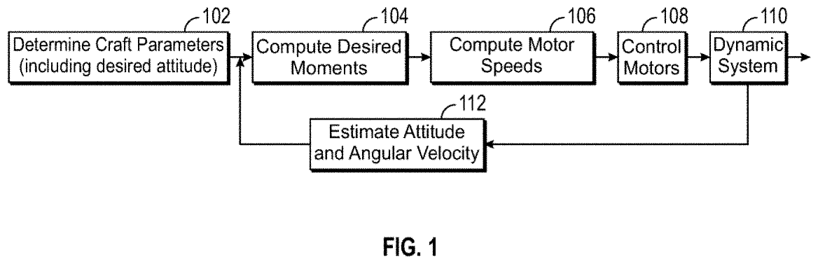

FIG. 1 shows a related art method for achieving attitude control without compensating for attitude disturbances imparted upon a unmanned aerial vehicle (UAV) from extraneous payloads. In Step 102, the aircraft's physical and dynamic parameters may be assessed and analyzed.

Examples of physical parameters may include factors relating to aircraft structure and/or aircraft dynamics. The physical parameters may include spatial dimensions, such as height, width, length, diameter, diagonal, or circumference. The physical parameters may also take morphology of the aircraft into account, such as shape of the aircraft body and/or any extensions. The physical parameters may also take other factors into account, such as weight, weight distribution, center of gravity, or density. In some instances, one or more material properties of the aircraft may be taken into account, such as density, rigidity, flexibility, or elasticity may be taken into account. Such physical parameters may relate to aircraft structure. The physical parameters may be gathered for the aircraft as a whole and/or one or more components of the aircraft. For example, the physical parameters may pertain to the aircraft frame, power source (e.g., battery), avionics system, carrier, payload, sensors, motors, landing gear, communication unit, or any other component.

Dynamic parameters may include electronic specifications or other power source specifications, or motor characteristics, such as thrust or power. This may include power source specifications, such as maximal battery current, maximal power output, energy density, battery capacity, discharge rate, rating voltage, battery life, or any other features. In some instances, information about battery chemistry or type of battery may be specified or determined. This may also include motor characteristics, such as thrust or power. In some instances, motor characteristics may include maximal thrust and maximal power.

Information about one or more of the aircraft's physical or dynamic parameters may be stored in memory. For example, the physical parameter data may be stored in one or more databases. The databases may be external to the aircraft. The databases may be stored in a cloud computing environment and/or may be distributed over multiple devices. Alternatively, the databases may be stored on-board the aircraft.

Relationships between physical and dynamic parameters may be established thereby predicting the reaction of one or more parameters with respect to a given change of another parameter. For example, for a given change in current applied to an aerial actuator such as a spinning propellor or other thrust producing device, a net force or torque may be expected upon the aircraft thereby leading to a net overall change in the aircraft orientation relative to an outside reference frame. These relationships may be stored in memory as described above and elsewhere herein.

In Step 102 the preferred position, orientation, or trajectory may also be determined. The preferred position, orientation, or trajectory may be based on some operational objective set by the user. In one example, a user may desire the aircraft to hover relative to an outside reference frame. The outside reference frame may be the surface of the earth, or some other exterior object. In some applications, the preferred orientation may be to maintain an altitude above ground and a horizontal and stable attitude relative to the ground. If the user does not desire movement, then there may be no preferred trajectory. If the user desires the aircraft to remain in a specific position relative to an outside point of reference, then that may determine the preferred position. In general, the preferred position, orientation, and trajectory may be described in various terms including but not limited to: position, velocity, acceleration, angle, angular velocity, and angular acceleration with respect to one or more outside frames of reference. The preferred position, orientation, trajectory and outside reference frame may be dependent upon the application intended for the UAV at the time of use. The preferred position, orientation, trajectory may change with time, or other variables. The preferred position, orientation, or trajectory data may be continuously updated and fed forward into Step 104.

The preferred position, orientation, or trajectory may be stored in memory. For example, the parameter data may be stored in one or more databases. The databases may be external to the aircraft. The databases may be stored in a cloud computing environment and/or may be distributed over multiple devices. Alternatively, the databases may be stored on-board the aircraft.

In Step 104, the forces and moments required to achieve a preferred aircraft position, orientation or trajectory may be calculated. This may be done by applying the laws of physics to the craft parameter data determined in Step 102. Such calculations may require information about the aircraft's preferred position, orientation, or trajectory, which may be predetermined based on some operational objective set by the user. In one example, a user may desire the aircraft to hover relative to an outside reference frame. The outside reference frame may be the surface of the earth, or some other exterior object. In many applications, the preferred orientation may be to keep a constant altitude above the ground and a horizontal and stable attitude relative to the ground. If the user does not desire movement, then there is no preferred trajectory. If the user desires the aircraft to remain in a specific position relative to an outside point of reference, then that may determine the preferred position. In general, the preferred position, orientation, and trajectory may be described in terms of position, velocity, acceleration, angle, angular velocity, and angular acceleration with respect to one or more outside frames of reference. The particular position, orientation, trajectory and outside reference frame may be dependent upon the application intended for the UAV at the time of use.

Step 104 may receive feedback data regarding the aircraft's actual position, orientation, and trajectory based on Step 112 described below. By comparing the actual position, orientation, or trajectory with the preferred position, orientation, or trajectory, the moments and/or forces necessary to reconcile the differences between them may be calculated.

In Step 106, individual motor speeds may be computed. It may be possible to correlate a desired force and/or moment with a specific input from the aircraft's force and/or torque producing components. For example, a rotor blade thruster may apply a specific force and/or moment on the aircraft at a given throttle. By summing the net forces and/or moments created by all force/moment producing components, one may be able to calculate the necessary operation of each component such that the net overall effect on the aircraft matches the desired forces and/or moments calculated in Step 104. In one non-limiting example, the force and moment mechanisms may be rotor blade thrusters with a controllable throttle. By altering the throttle, the amount of force and torque exerted on the aircraft may be controlled. If the thruster has a thrust-vectoring capability, the direction of the thrust may also be taken into account. Other methods of applying force to an aircraft including gyroscopic mechanisms, flywheels, or electromagnetic components are available.

In Step 108, the individual motor speeds calculated in Step 106 may be executed by modulating the power inputs to each component such that their actual performance matches their desired performance. This often involves increasing or decreasing voltage or current as necessary, but other inputs may be involved. For example, some thrust producing components may require modulating a fluid's volumetric flow rate or speed. The system for controlling the force and/or moment producing components may be done with the aid of a processor.

In Step 110, UAV 200 may react in three dimensional space based upon the forces and/or moments applied to it by all sources. This may include transversal or rotational motion relative to a fixed outside reference frame.

In Step 112, the actual position, orientation, and trajectory of the aircraft may be estimated or calculated by analyzing data collected and sampled by various onboard or offboard sensing components. Non-limiting examples of sensor components may include light sensors such as cameras, photoresistors, phototubes, phototransistors, or photovoltaic cells; sound sensors such as microphones; temperature sensors such as a LM34, LM35, TMP35, or TMP 36 sensors; contact sensors such as push button switches, tactile bumper switches, or capacitive contact sensors such as touch screens; proximity sensors such as infrared (IR) transceivers, ultrasonic sensors, or photoresistors; distance sensors such as laser range sensors including LIDAR, and stereo cameras; pressure sensors such as a barometer; tilt sensors such as an analog mercury-suspension glass bulb sensor; positioning sensors such as global position system (GPS) sensors and digital magnetic compasses; acceleration sensors such as accelerometers; gyroscopes; inertial measurement units; electrical sensors such as voltmeters; radiofrequency sensors; radar; chemical sensors; or any other device capable of receiving or transmitting information or transforming environmental or motion information into an analytically useful signal.

The sensing components may generate an electrical signal proportional to the value of the metric being sensed. The sensing components may send electrical signals to a processing device for analysis. The analysis may be done onboard the aircraft or separately through wireless communications. The aircraft's preferred orientation may have shown a specific configuration with respect to electrical signals sent by the sensing components. Put another way, when the aircraft is stable in its preferred orientation, the sensing components may forward a specific configuration of electrical inputs to the processor. When the processor receives this pattern of inputs from the sensing components, the processor may assume the aircraft is currently in the preferred orientation. As the aircraft deviates from its preferred orientation, the configuration of electrical inputs forwarded by the sensing components may change. The processor may be able to calculate how far and at what rate the aircraft is deviating from the preferred orientation by measuring the difference in the electrical signals provided by the sensing components from the expected configuration when the aircraft is in its preferred orientation. It is possible that onboard components provide this analysis, but it is also possible for an external observation system to complete the analysis and then provide the data to the flight control systems. This information may be fed back into Step 104 such that new desired forces and/or moments may be continuously computed.

A feedback loop may be implemented such that the difference between the actual position, orientation, or trajectory and the preferred position, orientation, or trajectory may be continuously computed. It may be desirable to have high frequency cycles, for example, in the range of 100 Hz, 1000 Hz or higher.

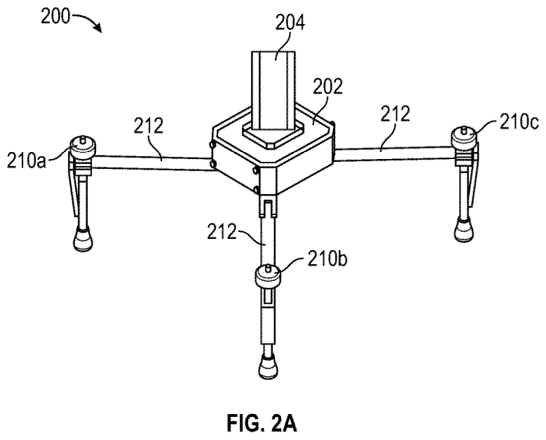

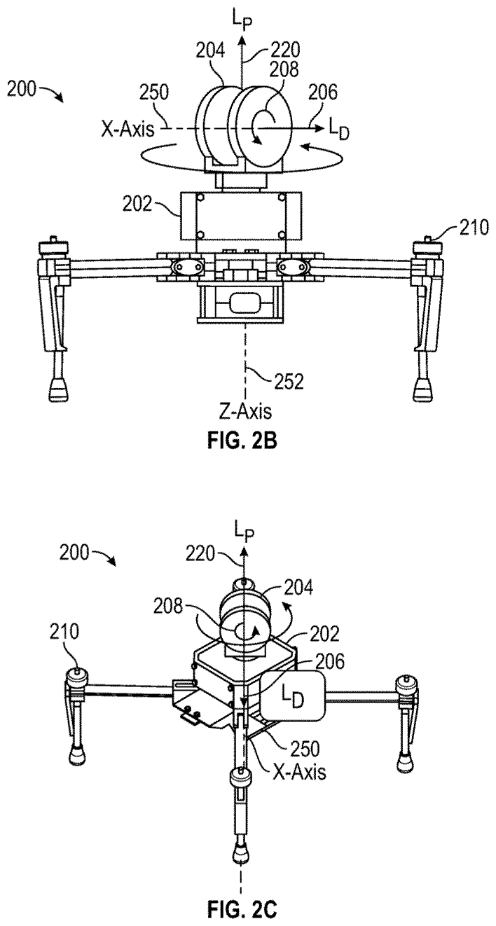

FIG. 2A shows a perspective view of an unmanned aerial vehicle UAV 200 according to an aspect of the present disclosure. UAV 200 may include an Airframe 202 that may house various flight control systems and provide structural support to UAV 200. Airframe 202 may include various computing and electrical components capable of storing and using electricity. Airframe 202 may be constructed out of lightweight but sturdy materials designed for use in aviation, including but not limited to, composites, plastics, or metals such as aluminum or titanium. Airframe 202 may attach to one or more Arms 212. Arm 212 may attach to the Airframe 202 at one end using various connective methods including screws, welds, interference fits, electromagnetic fits, or other similar technologies. Arms 212 may be constructed out of lightweight but sturdy materials designed for use in aviation, including but not limited to, composites, plastics, or metals such as aluminum or titanium. Arm 212 may provide structural support and electronic connections for Thruster 210. Thruster 210 may be an actuator device capable of generating forces upon the Airframe 202 through the connection of Arm 212. In some non-limiting examples, Thruster 210 may be various mechanisms capable of generating thrust in a gaseous atmosphere, including rotor, turbine, jet engine, or rocket engine. In other non-limiting examples, Thruster 210 may be mechanisms capable of generating thrust in other ways such as using electromagnets or ion propulsion. In some configurations, Thruster 210 may attach directly to Airframe 202 without the use of Arm 212. In one aspect of the present disclosure, Thruster 210 may be a rotor-blade thruster capable of generating lift within an atmosphere by spinning rotor-blades at high speed similar to a helicopter.

Still referencing FIG. 2A, UAV 200 may include a Payload 204 attached to Airframe 202. Payload 204 may be any payload that is carried or supported by UAV 200 and can vary depending on the application of UAV 200 and Payload 204 at the time of use. Payload 204 may be static or dynamic. A static Payload 204 may be any payload that has little or no movement relative to Airframe 202. Similarly, a static Payload 204 may have few or no internal mechanisms or components that move relative to Airframe 202. Some non-limiting examples of static Payload 204 may be a bucket of rocks or a parcel.

Payload 204 may also be dynamic. A dynamic Payload 204 may move relative to Airframe 202 or have internal mechanisms or components that move relative to Airframe 202. In some non limiting examples, Payload 204 may be a dynamic mechanism intended to assist with the flight and navigation of UAV 200, such as a rotating sensor, or a mechanism designed to perform some other task, such as a LiDAR sensor designed to collect and analyze environmental data. In some dynamic configurations, Payload 204 itself and/or its internal components may move relative to Airframe 202, either rotationally or transversally, or both, depending on the specific application at the time.

FIG. 2B shows a side view of the system according to an aspect of the present disclosure with a dynamic Payload 204. FIG. 2C shows the same configuration in a perspective view. Payload 204 may be stationary or mobile, depending on its intended application and may be capable of rotation or translation relative to UAV 200 while being supported by Airframe 202. In one non-limiting example, Payload 204 may be a gimballed LiDAR sensor capable of sensing the surrounding environment in a manner, thereby allowing the environment to be mapped in three dimensions. In this non-limiting example, Payload 204 may be capable of rotating on Airframe 202. Payload 204 may have Internal Mechanisms 208 that may be necessary for the specific application of Payload 204.

The dynamics of Internal Mechanisms 208 and Payload 204 may generate forces or torques upon UAV 200, capable of disturbing UAV 200's flight attitude. In some aspects, Payload 204 may spin about an axis relative to Airframe 202 and/or may have Internal Mechanisms 208 that spin about an axis relative to Payload 204. Similarly, Payload 204 or Internal Mechanisms 208 may move transversely relative to Airframe 202. Such movements may disturb UAV 200's flight attitude by shifting the center of mass of UAV 200 or by imparting new angular momentums upon UAV 200.

Still referencing FIG. 2B, in one non-limiting example, Payload 204 may rotate about a Z-Axis 252 relative to UAV 200. The rotation of Payload 204 may generate an angular momentum L_{P} 220. Internal Mechanisms 208 may rotate about the X-Axis 250 relative to Payload 204. The rotation of Internal Mechanisms 208 may generate an angular momentum L_{D} 206. As Payload 204 rotates relative to Airframe 202, the orientation of L_{D} 206 may also rotate relative to UAV 200. In some configurations, the movement of Payload 204 or Internal Mechanisms 208 may be oscillatory in nature.

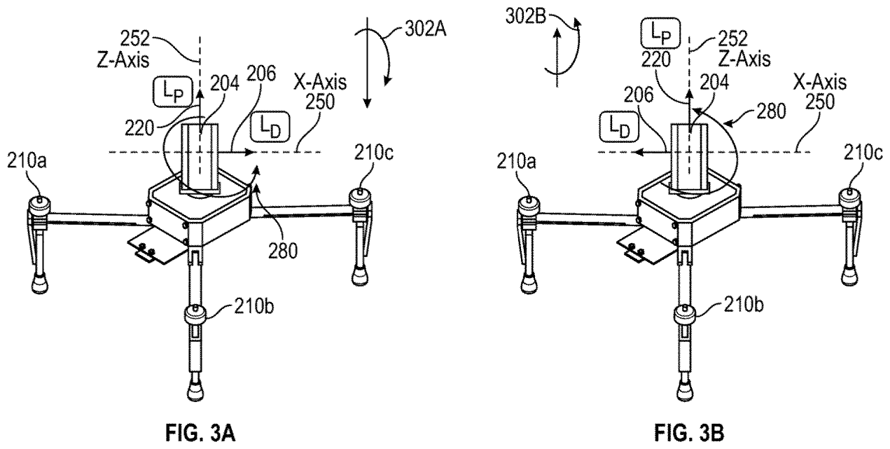

FIGS. 3A and 3B show a perspective view of the system according to an aspect of the present disclosure depicting two separate times in the rotation period of Payload 204. As Payload 204 progresses through its rotation, the angular momentum L_{D} 206 created by Internal Mechanisms 208 may change its orientation relative to UAV 200. The motion of Payload 204 and Internal Mechanisms 208 may impart new additional force and torque vectors upon Airframe 202 capable of disturbing the flight attitude of UAV 200. Net Force/Torque Vector 302A represents the total net forces and torques imparted upon UAV 200 by the motion of Payload 204 and Internal Mechanisms 208. These net forces and torques may be caused in different ways.

Movement of Payload 204 and/or Internal Mechanisms 208 transversely relative to Airframe 202 may induce new force or torque vectors upon Airframe 202 by altering the center of mass of UAV 200. Additionally, if any part of Payload 204 or its contents uncouples from UAV 200, e.g., ballistically or otherwise, there may be a recoil induced force or torque vector generated. Such forces may disturb the attitude and control of UAV 200 to the detriment of the intended application.

As Payload 204 spins about its axis, it may create gyroscopic forces due to its angular momentum. If the orientation of the angular momentum of Payload 204 is constant relative to Airframe 202, it may provide a corresponding disturbance of certain flight operations such as roll, pitch, or yaw, depending on its orientation. For example, as depicted in FIG. 3A, angular momentum L_{P} 220 may be generated by the rotation of Payload 204 about the Z-Axis 252. In static flight, i.e., UAV 200 is hovering relative to the ground with no translation or rotation, L_{P} 220 may not impart additional forces. However in dynamic flight, i.e., UAV 200 is moving relative to the ground, L_{P} 220 may impart additional forces on Airframe 202 when the orientation of L_{P} 220 changes relative to the ground. This may occur when UAV 200 attempts to pitch or roll, relative to the ground. If left uncompensated, such forces may interfere with the control and attitude of UAV 200 to the detriment of the intended application. If the orientation of the angular momentum of Payload 204 changes relative to Airframe 202, it may disturb flight attitude in both static and dynamic flight modes. Although not shown in FIG. 3A or 3B, Payload 204 may rotate about an axis with multiple orthogonal components relative to Airframe 202. Rotation about such an axis may generate an angular momentum vector in the direction of that axis with various effects on the attitude of UAV 200 depending on its orientation relative to Airframe 202.

As Internal Mechanisms 208 spin about their axis, they may create gyroscopic forces due to their angular momentum. If the orientation of the angular momentum of Internal Mechanisms 208 changes relative to Airframe 202, it may disturb flight attitude in both static and dynamic flight modes. As depicted in FIGS. 3A and 3B, in one non-limiting example according to an aspect of the present disclosure, the orientation of angular momentum L_{D} 206 may change relative to Airframe 202 as Payload 204 rotates about the Z-Axis 252. The rotation of L_{D} 206 about a Z-Axis 252 relative to Airframe 202 may induce additional forces and torques upon Airframe 202 that may disturb UAV 200's flight attitude. In static flight, the rotation of L_{D} 206 as depicted in FIG. 3A may induce a net force and/or moment on UAV 200 with an expected difference in phase angle of approximately Φ=−π/2 from L_{D} 206. The observed upwards deflection of UAV 200 may appear aligned with the direction of L_{D} 206. If L_{D} 206 rotates about the Z-Axis 252 relative to Airframe 202 and is currently pointed towards Thruster 210c as depicted in FIG. 3A, then it may impose a Net Force/Torque Vector 302A oriented towards Thruster 210b. Although not depicted in FIG. 3, Internal Mechanisms 208 may rotate about an axis with multiple orthogonal components relative to Payload 204. Rotation about such an axis may generate an angular momentum vector in the direction of that axis with various effects on the attitude of UAV 200 depending on its orientation relative to Airframe 202.

As Payload 204 spins about its axis, it may also generate a reaction torque as a result of being driven through a medium that imparts aerodynamic drag. In some configurations, as Payload 204 is driven to spin through a medium, a reaction torque may be applied to Airframe 202 that may cause UAV 200 to yaw in a direction opposite of the spin of Payload 204. If Payload 204 is spinning clockwise relative to Airframe 202, UAV 200 may tend to yaw in the counterclockwise direction. Without a counterbalancing torque, the spin of Payload 204 may cause UAV 200 to yaw uncontrollably. The spin of Payload 204 may also result in a constant yaw offset from the desired yaw. However this may not occur in all configurations. In some configurations where the rotation of Payload 204 is slow relative to Airframe 202, the reaction torque generated by aerodynamic drag may be negligible. In general, as Payload 204 increases in angular velocity, or as the surrounding atmosphere increases in viscosity, the net reaction torque may increase. The aerodynamic properties of Payload 204 may also increase or decrease the reaction torque. Although not depicted in FIG. 3, Payload 204 may rotate about an axis with multiple orthogonal components relative to Airframe 202. Rotation about such an axis may generate reaction torques in the opposite direction of Payload 204's rotation with various effects on the attitude of UAV 200 depending on the orientation relative to Airframe 202.

The net unbalanced forces and torques described above, when generated by the motion of Payload 204 or Internal Mechanisms 208, may be consolidated into a Net Force/Torque Vector 302. Net Force/Torque Vector 302A may describe, at a discrete moment in time, the sum of all additional forces and torques exerted upon UAV 200 from the motion and operation of Payload 204 and Internal Mechanisms 208 as depicted in FIG. 3A. It should be understood that Payload 204 may operate with 6 degrees of rotational and transversal freedom relative to Airframe 202 and motion within these degrees of freedom may impart additional forces and torques on UAV 200 as described above. Similarly, Internal Mechanisms 208 may operate with 6 degrees of rotational and transversal freedom relative to Payload 204, and motion within these degrees of freedom may also impart additional forces and torques on UAV 200 as described above. The net forces and torques created by the operation of Payload 204 and Internal Mechanisms 208 may be consolidated into a single Net Force/Torque Vector 302. Net Force/Torque Vector 302A may change its orientation relative to UAV 200 depending on the positions of Payload 204 and Internal Mechanisms 208 relative to UAV 200.

In one aspect of the present disclosure as depicted in FIGS. 3A and 3B, Payload 204 and Internal Mechanisms 208 may have a constant rotation about their respective axes. FIG. 3A shows a perspective view of the system at phase angle Φ=0, where L_{D} 206 may point towards Thruster 210c relative to Airframe 202. The Payload 204 may be capable of spinning about the Z-Axis 252 as shown in Rotation 280. In one non-limiting aspect of the present disclosure, UAV 200 may be in static flight, i.e. hovering relative to the ground with no transversal or rotational movement. In this specific non-limiting example, the reaction torque generated by the rotation of Payload 204 may be deemed negligible. As Payload 204 spins, the orientation of angular momentum L_{D} 206 may change relative to the airframe. Net Force/Torque Vector 302A may be the sum of additional forces and torques exerted upon UAV 200 by the angular momentum L_{D} 206 at phase angle Φ=0 in the oscillation period. Net Force/Torque Vector 302A may cause UAV 200 to deviate from its preferred orientation absent a counterbalancing force and/or moment acting upon UAV 200. As depicted in FIG. 3A, Net Force/Torque Vector 302A may point towards Thruster 210c, causing UAV 200 to tend to pitch down relative to the ground in the direction of Thruster 210b.

FIG. 3B shows a perspective view of the system at phase angle Φ=π, where L_{D} 206 may point towards Thruster 210a relative to Airframe 202. The Payload 204 may be capable of spinning about the Z-Axis 252 as shown in Rotation 280. As Payload 204 spins, the orientation of angular momentum L_{D} 206 may change relative to the airframe. Net Force/Torque Vector 302B may be the sum of additional forces and torques exerted upon UAV 200 by the angular momentum L_{D} 206 at phase angle Φ=π in the rotation period. Net Force/Torque Vector 302B may cause UAV 200 to deviate from its preferred orientation absent a counterbalancing force and/or moment acting upon UAV 200. As depicted in FIG. 3B, Net Force/Torque Vector 302A may be offset from L_{D} 206 with an expected difference in phase angle of approximately Φ=−π/2 from of L_{D} 206. When L_{D} 206 is oriented towards Thruster 210a as depicted in FIG. 3B, Net Force/Torque Vector 302B may be oriented towards Thruster 210d (not pictured in FIG. 3B as it is hidden from view). The observed upward deflection of UAV 200 may appear aligned with L_{D} 206. As L_{D} 206 progresses through its oscillation cycle, the orientation of Net Force/Torque Vector 302 may change relative to Airframe 202.

It is to be understood that although L_{D} 206 and L_{P} 220 (and resulting Net Force/Torque Vector 302) are represented in a specific configuration in these Figures, many different configurations are possible. Depending on the design and intended function of Payload 204, angular momentums may be generated in any direction and in many different combinations. This may be determined by the configuration and inner workings of Internal Mechanisms 208, which cause Payload 204 to perform the intended function. Although it is impossible to display all possible configurations of angular momentums caused by the operation and function of Payload 204, if a specific configuration were known it may be possible to calculate the Net Force/Torque Vector 302 expected upon the aircraft across the entire oscillatory period (if Payload 204 has such oscillatory period).

As described previously in FIG. 1, UAV 200's attitude controller may attempt to calculate and issue corrective instructions, in an attempt to restore UAV 200 to the preferred orientation, however by the time corrective instructions are implemented, Net Force/Torque Vector 302 may have progressed to a different orientation relative to UAV 200, thereby imparting a different force upon the airframe, leading to a different attitude deflection that has not yet been analyzed by UAV 200's attitude controller. As a result of the attitude controller's compensation inputs being out of phase with the attitude disturbance caused by Net Force/Torque Vector 302, UAV 200 may wobble around thereby frustrating UAV 200's intended purpose.

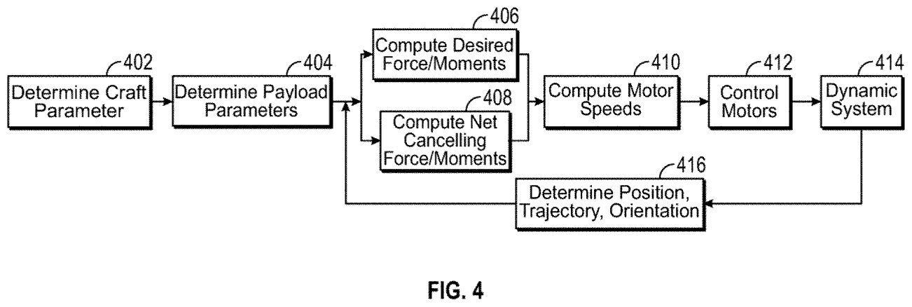

FIG. 4 shows a method for maintaining aircraft attitude while compensating for additional Net Force/Torque Vectors 302, according to one aspect of the present disclosure. In Step 402, the aircraft's physical and dynamic parameters, along with the preferred position, orientation, and trajectory may be continuously assessed and analyzed. This may be done in a manner similar to those described in connection with Step 102 in FIG. 1. The data may be fed forward into Step 404.

In Step 404, the physical and dynamic parameters of Payload 204 may be assessed, analyzed or experimentally estimated. This may include an analysis of Internal Mechanisms 208. Examples of physical parameters may include factors relating to Payload 204 structure. The physical parameters may include spatial dimensions, such as height, width, length, diameter, diagonal, or circumference. The physical parameters may also take morphology of Payload 204 and Internal Mechanisms 208 into account, such as shape of the body and/or any extensions. The physical parameters may also take other factors into account, such as weight, weight distribution, center of gravity, or density. In some instances, one or more material properties of Payload 204 and Internal Mechanisms 208 may be taken into account, such as density, rigidity, flexibility, or elasticity. The physical parameters may be gathered for Payload 204 and Internal Mechanisms 208 as a whole and/or one or more components of the structure. For example, the physical parameters may pertain to the structure frame, power source (e.g., battery), avionics system, carrier, payload, sensors, motors, communication unit, or any other internal component. This may be done with the aid of a processor.

Dynamic parameters may include physical effects of Payload 204 and Internal Mechanisms 208 operation, including any extraneous physical effects applied to, on, or about UAV 200. These extraneous effects may be generated by operation of components internal to Payload 204 and Internal Mechanisms 208. Oscillating devices may impart additional forces or torques on UAV 200 due to the presence of single or multi-axis angular momentums. Electromagnetic components may cause unintended electrical activity in UAV 200's electrical components, for example, an electromagnetic device within Payload 204 and Internal Mechanisms 208 may generate extraneous currents in the electrical components connected to UAV 200's thrust producing components, causing them to produce more or less thrust than intended, or in an unintended direction. These parameters may be assessed and analyzed, with their effects on UAV 200 understood and predicted. This may be done with the aid of a processor. The data obtained in Steps 402 and 404 may be refreshed at high frequency and continuously fed forward into Steps 406 and 408.

In Step 406, the forces and moments required to achieve a preferred UAV 200 position, orientation or trajectory may be calculated. This may be done by applying the laws of physics to the UAV 200 parameter data determined in Step 402. Such calculations may require information about UAV 200's preferred position, orientation, or trajectory, which may be based on an operational objective set by the user. In one example, a user may desire UAV 200 to hover relative to an outside reference frame. The outside reference frame may be the surface of the earth, or some other exterior object. In many applications, the preferred orientation may be to keep a constant altitude above the ground and a horizontal and stable attitude relative to the ground. In general, the preferred position, orientation, and trajectory may be described in terms of position, velocity, acceleration, angle, angular velocity, and angular acceleration with respect to one or more outside frames of reference.

In Step 408, the forces and moments required to cancel Net Force/Torque Vector 302 at a discrete point in time may be computed. By applying the physical and dynamic relationship parameters described in Steps 402 and 404, one may calculate forces and moments to substantially negate Net Force/Torque Vector 302 at a discrete point in time. If Net Force/Torque Vector 302 is not properly accounted for, the forces and torques calculated in Step 406 may not return UAV 200 from its actual position, attitude, or trajectory as measured in Step 416 to the desired position, attitude, or trajectory as calculated in Step 402 because Net Force/Torque Vector 302 may impart unbalanced forces and torques on UAV 200, which may alter or interfere with UAV 200's movement through three dimensional space. This may be done with the aid of a processor.

In Step 410, the individual motor operation may be computed. It may be possible to correlate a desired force and/or moment with a specific input from the aircrafts force and/or torque producing components. For example, a rotor blade thruster may apply a specific force and/or moment on the aircraft at a given throttle. By summing the net forces and/or moment created by all force/moment producing components, one may be able to calculate the necessary operation of each component such that the net overall effect on the aircraft matches the desired forces and/or moments calculated in Steps 406 and 408. Step 410 in FIG. 4 may be distinguishable from Step 106 in FIG. 1 in that Step 410 may also take into account inputs to cancel Net Force/Torque Vector 302 while still causing the net overall force/moment to return UAV 200 to the preferred position, orientation, or trajectory.

As mentioned previously, there are multiple ways to impart additional controllable forces or moments upon UAV 200. In one non-limiting example system according to an aspect of the present disclosure wherein Thrusters 210 are the preferred force and moment generating component, a thrust vector profile may be determined containing a description of thrust vectors to be executed by the individual Thruster 210 components such that the overall net force and torques applied to Airframe 202 is substantially equal to the net force and/or moment required to return UAV 200 to the preferred position, orientation, or trajectory. This profile may include throttle percentages, thrust forces, flow rates, electrical information such as current or voltage, and other similar metrics. If Thrusters 210 are capable of thrust vectoring, the orientations of each Thruster 210 may also be factored into the thrust vector profile.

In one non-limiting example wherein a LiDAR sensor causes a revolving net downward pitching torque to one side of UAV 200, the system in Step 408 may calculate the necessary thrusts required by UAV 200's Thruster 210 components to generate a countering force or moment, e.g., an equal but opposite upward pitching torque on UAV 200.

In Step 412, the motor operations calculated in Step 410 may be executed by modulating the power inputs to each component such that their actual performance matches their desired performance. This often involves increasing or decreasing voltage or current as necessary, but other inputs may be involved. For example, some thrust producing components may require modulating a fluid's volumetric flow rate or speed. The system for controlling the force and/or moment producing components may be done with the aid of a processor. In one non-limiting example, the rotation speed of one or more rotor engines may be modulated by altering voltage or current, causing more or less thrust to be produced.

In Step 414, UAV 200 may react in three dimensional space based upon the forces and moments applied to it by all sources. This may include transversal and/or rotational motion relative to a fixed outside reference frame.

In Step 416, the actual position, attitude, or trajectory of UAV 200 may be estimated or determined. This may be done in many different ways, including, by non limiting examples, onboard information tracking devices such as GPS chips; or external determination such as observer based motion capture systems. The system may measure the actual craft position, attitude, or trajectory and forward analytically useful signals containing such orientation, trajectory, and/or position information for comparison to the preferred position, attitude, or trajectory described in Step 402. This may be done with the aid of a processor. This data may be continuously fed back into the system after Step 404 but before Steps 406 and 408. By having a feedback loop, the system may be able to self correct continuously.

For illustrative purposes, in the non limiting example of a spinning LiDAR sensor with internal spinning mechanisms that generate an angular momentum L_{D} 206 that is horizontally co-planar to the airframe as shown in FIGS. 2 and 3, the momentum of Payload 204 may be modeled as a constant vector L_{D}∈ [symbol] ³ in the device reference frame. The vector in the robot frame may be computed by the current orientation of the device R_{D}∈SO(3) relative to the vehicle frame. In the quasi-static scenario (i.e. the vehicle is hovering), the torque τ∈ [symbol] ³ exerted on the device may be given by

$${τ}_{D} ( t ) = \frac{d}{dt} ( {R}_{D} ( t ) {L}_{D} ) = {\hat{Ω}}_{D} ( t ) {R}_{D} ( t ) {L}_{D}$$

where \hat{Ω} denotes the skew symmetric form of the angular velocity and may be defined such that

âb=a×b∀a,b∈ [symbol] ³.

We may assume that Ω_{D} is defined as the angular velocity of the device expressed in coordinates of the vehicle frame. In the non quasi-static scenario, the orientation and angular velocity may be given in the inertial frame. The expected Net Force/Torque Vector 302 may be computed based on the orientation and angular velocity of the device. Then, the torque required for compensation may be passed as feed-forward moments to the flight controller for compensation. If a nominal angular acceleration is known for the body of the vehicle, it could be used to more accurately estimate the necessary feed-forward torques to compensate for the angular momentum internal to the device.

It is important to note that for some applications, the Net Force/Torque Vector 302 may have an oscillating effect on UAV 200, although this is not necessary in every case. For cases where Net Force/Torque Vector 302 does oscillate, the corresponding control scheme and resulting net cancelling force may also oscillate. It may be desirable for the response to be exactly in phase with Net Force/Torque Vector 302. If the corrective input is not in synchronous phase with the oscillating disturbance, the aircraft may wobble similar to how it does when corrections are left to the general attitude controller. If the corrective inputs are perfectly out of phase with the oscillating disturbance (meaning the disruptive forces are additive, rather than subtractive), then UAV 200 may experience a catastrophic failure and crash. If the corrective inputs are perfectly in phase with the oscillating disturbance, then there may be little or no observable deviation from the preferred position, attitude, or trajectory determined in Step 402.

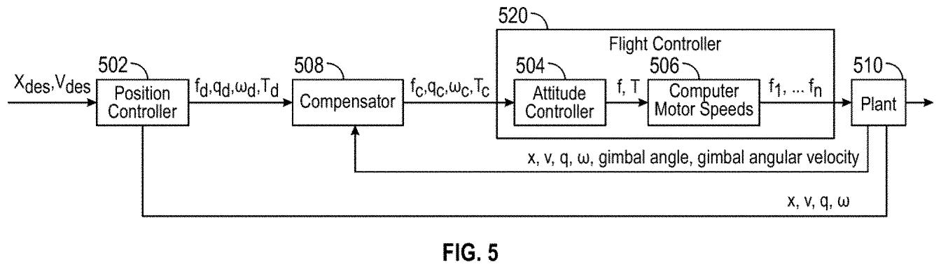

FIG. 5 is a diagram of a system according to an aspect of the present disclosure wherein the system may contain a Flight Controller 520 capable of accepting feed-forward torques from the Position Controller 502. Flight Controller 520 may be a system or process, typically containing one or more processors, that may include the systems of Attitude Controller 504 and Processor 506. Position Controller 502 may be a device or method, typically a processor, capable of analyzing UAV 200's trajectory, position and/or attitude in three dimensional space. Position Controller 502 may be capable of determining course and/or attitude corrections based upon position data received from Plant 510 as part of a feedback loop. In one non-limiting example, desired position x_{d} and desired velocity v_{d} may be determined by an alternative plant prior to Position Controller 502 on the system diagram, however these quantities may be determined by Position Controller 502 as well. Position Controller 502 may then forward analytically useful signals to Compensator 508. In one aspect, Position Controller 502 may forward force f_{d}, desired attitude q_{d}, desired angular velocity ω_{d}, and desired torque T_{d}, to Compensator 508.

Compensator 508 may be a system or process, typically a processor, capable of analyzing the Net Force/Torque Vector 302 induced by Payload 204 and Internal Mechanisms 208, and then computing the necessary force and/or moment profile required to cancel out Net Force/Torque Vector 302. Compensator 508 may apply its analysis to the incoming inputs from Position Controller 502 thereby changing them into new quantities. Compensator 508 may forward the new “compensated” values to Flight Controller 520 containing systems including Attitude Controller 504 and Processor 506. In this aspect, Compensator 508 may only change the torque T, while passing the other quantities through. Compensator may forward force f_{c}, attitude q_{c}, angular velocity ω_{c}, and “compensated” torque T_{c}, to Flight Controller 520 containing Attitude Controller 504, wherein force f_{c}, attitude q_{c}, angular velocity ω_{c}, are unchanged.

Attitude Controller 504 may be a system or process, typically a processor, capable of analyzing and processing input signals received from Compensator 508. Attitude Controller 504 may compute the total force f or torque T required from each of UAV 200's force and/or moment producing components such that the net overall force and torque on UAV 200 matches the force f_{c} and “compensated” torque T_{c} as fed-forward by Compensator 508. In one non-limiting example wherein the only force and moment producing components are Thrusters 210, Attitude Controller 504 may compute how much force is necessary from each Thruster 210 to create the required overall force f and/or torque T on UAV 200 as specified by the compensated force f_{c} and compensated torque T_{c} determined by Compensator 508. Alternatively, Attitude Controller 504 may simply output a net force f and torque T relative to UAV 200 as a whole, while Processor 506 may compute the specific force or torque is required from each individual component.

Processor 506 may be a system or process, typically a processor, capable of analyzing and processing input signals received from Attitude Controller 504. In one aspect, Attitude Controller 504 and Processor 506 may be combined into a single element, but can be separate elements as well. Processor 506 may convert the mathematical force and torque models computed for each force and/or moment producing component by Attitude Controller 504 into analytically useful signals to be sent to said components. Alternatively, if Attitude Controller 504 outputs a total net force and thrust signal, Processor 506 may compute the necessary force and torques required from each force and/or moment producing component prior to computing the appropriate control signals for each component. The control signals may modulate the operation of each component such that forces f₁ . . . fₙ and/or moments of each component, or total net force and/or moment exerted on UAV 200, match the quantities specified by Attitude Controller 504. In one non-limiting example wherein the only force and/or moment producing component are Thrusters 210, Attitude Controller 504 may compute how much thrust f₁ . . . fₙ is required from each Thruster 210 for n number of thrusters. Alternatively, Attitude Controller 504 may output a net force f and torque T, while Processor 506 may compute the specific force or torque required from each individual Thruster 210. Processor 506 may then compute how much power is required to operate each Thruster 210 such that they provide the required thrust. As specified above, Attitude Controller 504 and Processor 506 may be combined into a single physical element, but they may also be separate.

Plant 510 may be the actuator and thrust components, including Thrusters 210, capable of converting the electrical signals received from Processor 506 into physical forces exerted upon UAV 200's airframe. Plant 510 may also include other dynamic system components necessary to implement the control loop described in FIG. 5, such as sensors, accelerometers, electrical components, gimbals etc.

A feedback loop from Plant 510 to Position Controller 502 may be desired such that UAV 200's actual position, velocity and other flight characteristics are adjusted with high frequency. Plant 510 many include onboard or exterior components capable of estimating or determining UAV 200's current position x, velocity v, attitude q, and angular velocity ω at a specific moment in time. This data may be fed back into the Position Controller 502, thus allowing Position Controller 502 to compare the actual position x, velocity v, attitude q, and angular velocity ω with the desired position x_{d} and desired velocity v_{d} in order to compute an appropriate response. The outputs of Position Controller 502 may try to reconcile the differences between current position x, velocity v and desired position x_{d}, desired velocity v_{d} such that the system may become self-correcting. It may be preferable to have high frequency cycles, in the range of 100 Hz or higher.

A feedback loop from Plant 510 to Compensator 508 may be desired such that UAV 200's actual position, velocity and other flight characteristics are adjusted with high frequency. Plant 510 many include onboard or exterior components capable of estimating or determining UAV 200's current position x, velocity v, attitude q, and angular velocity ω at a specific moment in time. There may also be gimbal components within Plant 510 capable of forwarding gimbal angle and gimbal angular velocity to Compensator 508 as part of the feedback loop. This may allow Compensator 508 to compensate for various effects of Net Force/Torque Vector 302 within the control loop. Compensator 508 may convert the output quantities of Position 502 into new quantities that achieve the intended output of Position Controller 502 while also cancelling out Net Force/Torque Vector 302. It may be preferable to have high frequency cycles, in the range of 100 Hz or higher.

In another non-limiting aspect of the present disclosure that is not shown in FIG. 5, the system described in FIG. 5 may involve a Flight Controller 520, including Attitude Controller 504 and Processor 506, that may not accept feed-forward torque inputs from Position Controller 502 and Compensator 508. In this aspect, the analytically useful output of Position Controller 502 may only be force f and desired attitude q_{d} because Attitude Controller 504 may only accept force f and desired attitude q_{d} data as usable input. In this aspect, Compensator 508 may then compute a perturbation of q_{d}, transforming it into q_{c}. Compensator 508 may then forward “compensated” output q_{c} to Attitude Controller 504 along with force f that is unchanged.

Attitude Controller 504 may then compute the net overall force and torque to be exerted on UAV 200 such that they may cause UAV 200 to achieve the desired attitude. Attitude Controller 504 may then compute the total force or torque required from each of UAV 200's force and/or moment producing components such that the sum of all forces and torques on UAV 200 matches the net overall force and torque required to obtain desired attitude q_{c}. In this aspect, despite not accepting feed-forward torques from Position Controller 502 or Compensator 508, Attitude Controller 504 may compute a torque that is substantially similar to the sum of T and T_{c} as computed by the Flight Controller 520 in the previously described aspect which can accept feed-forward torque data. In one non-limiting example wherein the only force and moment producing components are Thrusters 210, Attitude Controller 504 may compute how much force is necessary from each Thruster 210 to create the required overall forces and/or torques on UAV 200 as specified by the compensated force f_{c} and compensated torque T_{c} as desired by Compensator 508. In this aspect, the system may also include the feedback loops discussed above.

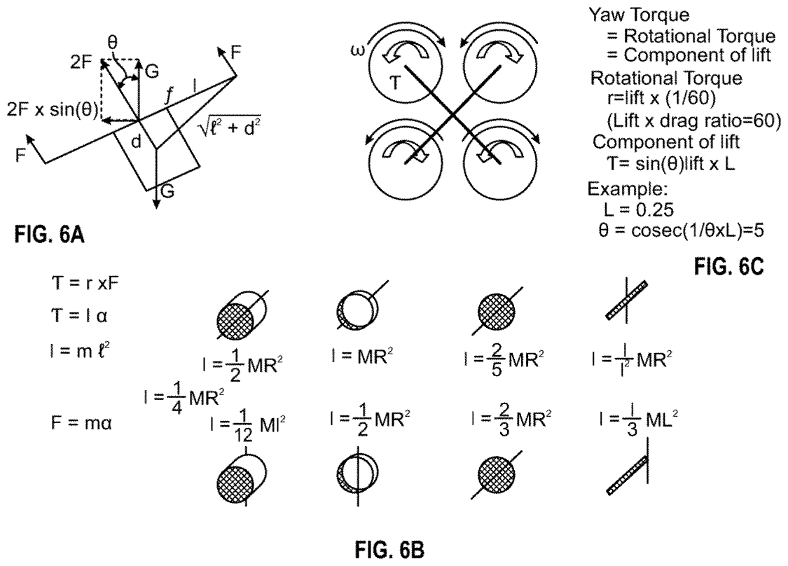

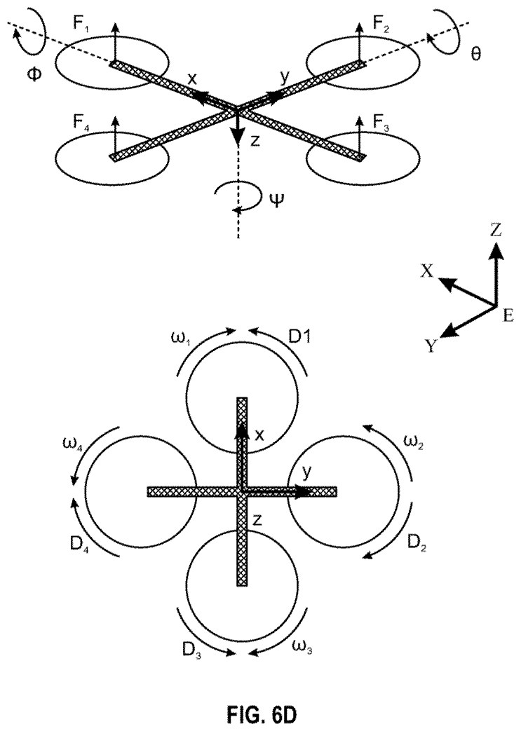

FIG. 6 shows an example of various physical characteristics that may be considered for one or more physical parameters of an aircraft, in accordance with an aspect of the present disclosure. FIG. 6A shows an example of how a center of gravity of an aircraft may be calculated. As shown, when the aircraft center of gravity is situated under the lift surface, when the aircraft lateral flight may reach a constant equilibrium velocity, the horizontal component of the lift force may counteract the drag force, and/or the vertical component may counteract gravity. In some instances, the aerodynamic center and gravity may or may not coincide. In a situation where the aerodynamic center and the center of gravity do not coincide, the vertical lift component and gravity may form a force couple, causing the aircraft to experience a nose-up pitching moment. This may cause the aircraft to tend towards the horizontal, which may permit the aircraft to become a stable system. Thus during aircraft design, the position of the center of gravity can be changed to adjust the aircraft's stability. The center of gravity of the aircraft may be calculated based on the physical parameters. In some instances, the weight distributions and positioning of various components of the aircraft may be considered to determine the center of gravity of the aircraft. The center of gravity may differ from aircraft model to aircraft model.

FIG. 6B shows an example of how a moment of inertia of the aircraft may be calculated. In some embodiments, the entire aircraft's moment of inertia distribution may be analyzed. The influence of the aircraft model and the configuration of the payload may be assessed for their effect on the entire aircraft's moment of inertia. These can be used as a reference to adjust the aircraft's entire configuration.

The basic physical models making up each component of an aircraft may be established. Examples of aircraft components may include, but are not limited to, aircraft frame, power source (e.g., battery), avionics system, carrier, payload, sensors, motors, propulsion units, landing gear, or communication unit. The basic models may include installation location, weight, and terms relating to each component's moment of inertia. Then, using the parallel axis theorem, the entire aircraft's moment of inertia may be determined based on the moments of inertia of each component. As illustrated, the shapes of the various components and/or the aircraft as a whole and weight distribution may be considered in calculating the moment of inertia. The moment of inertia may be calculated with aid of a processor based on the gathered physical parameters. In some implementations, finite element analysis (FEM) may be employed. The parallel axis theorem may be used in calculating the moment of inertia.

Some example of moment of inertia calculations may be provided as follows:

1) Particle: I=M*L\hat{ }2

2) About a portion of a cylinder: I=⅓*M*L\hat{ }2

3) About the center of a cylinder: I=½*M*R\hat{ }2 wherein I is the moment of inertia, M is the mass, L is the distance from the center of the particle or cylinder (or any other shape) to the axis of rotation and R is the radius of the cylinder.

Additional calculations may include torque and angular velocity calculations, which may be provided as follows: torque=length*force; angular velocity=torque/moment of inertia.

Based on theoretical analysis and calculation of a large number of aircraft models, the sought-for primary moment of inertia of the aircraft may be about 50% allocated by the electronics and propulsion unit (e.g., propellers/rotor blades). Because the moment of inertia and the rotor distance may be related by a squared relationship, and the torque increases linearly, with the same propulsion, under small rotor distance conditions there may be better agility characteristics, under large rotor distances there may be better stability characteristics.

Additionally, other aircraft configuration parameters that may be considered may include power source (e.g., battery) parameters, actuator (e.g., motor) parameters, and/or electronic speed control (ESC) parameters.

Furthermore, it may be desirable to assess the propulsion system's safety and/or compliance. For instance, it may be desirable that the current that can be provided by the battery>ESC's maximal current>motor's current.

An additional calculation of aircraft configuration parameters from physical parameters may include a hover performance assessment. For example, based on the aircraft's weight and dynamics, a calculation may be made for the hover power output, power usage amount, efficiency, power, and/or estimated hover time. The calculation may be performed with aid of a processor.

The motor output can be determined from accessing data regarding the motor in one or more databases. In some instances, the data regarding the motor may be a look up table based on the aircraft's weight and motor torque curve, and the efficiency can be determined from a look up table based on the motor output. The look up table may be created based on empirical test data. Alternatively, the look up table can be created based on simulated or projected data. In some instances, data on the loop up table may be entered by an individual. Optionally, the motor tension curve may be non-linear.

One or more hover characteristics may be calculated as follows: hover power=weight/efficiency hover current=hover power/voltage time=battery capacity/hover current.

Additionally, the physical parameters may be used to perform an actuation performance assessment. One or more aircraft configuration parameters from the actuation performance assessment may include, but are not limited to thrust-to-weight ratio, parameters relating to speed (e.g., maximal ascending speed, maximal descending speed, upper speed limit based on designed braking distance), parameters relating to angle (e.g., theoretical maximum attitude angle, attitude angle after compensation, limit to attitude angle), parameters relating to torque (e.g., three-axis torque), parameters relating to angular velocity (e.g., using braking angle to calculate maximum angular velocity), parameters relating to motor rotation (e.g., calculate influence of motor rotation direction on a yaw axis, and/or associated compensation).

FIG. 6C shows an example of motor rotation direction on one or more control parameters, which may be aircraft configuration parameters. One or more of the aircraft configuration parameters may also be calculated as follows: thrust-to-weight ratio=maximal thrust/weight hover lift force (N)=entire aircraft weight (kg)*9.8 (m/s\hat{ }2) hover throttle=look up(lift force), units: % hover efficiency=look up(hover throttle), units: g/watt hover braking efficiency=look up(hover throttle), units: g/watt hover current=entire aircraft weight/efficiency hover time=battery capacity/hover current maximal attitude angle=arcos(hover lift force/maximal lift force)

As shown in FIG. 1, the aircraft configuration parameters may be calculated based on the one or more physical parameters from the aircraft. The aircraft configuration parameters may be associated with an aircraft model. For example, different aircraft models (e.g., UAV models, manned aircraft models) may have different physical parameters and associated aircraft configuration parameters. The aircraft configuration parameters may be collected and/or stored for each of the models. In some instances, some of the aircraft configuration parameters may include data that was received empirically, manually entered by a user, modeled or simulated, or calculated based on any existing data.

One or more aircraft configuration parameters may include controller parameters that may be used to tune an aircraft flight controller. For example, the aircraft's moment of inertia, motor torque curve, and dynamic acceleration/deceleration performance may be used to automatically tune controller parameters. Such tuning may occur according to tracking error. Using the aircraft configuration parameters may simplify the parameter tuning process and enhance controller performance.

In some embodiments, providing the aircraft's moment of inertia, motor lift output curve, and/or axial distance (e.g., distance from motor to aerodynamic center) may enhance controller performance. Such parameters may be useful for differentiating different aircraft models. Such parameters may be associated with an aircraft model. Thus, when a user receives an aircraft, the user may specify the aircraft model, or the aircraft model may already be pre-programmed in. The parameters for the specific aircraft models may be used in the flight control system to control the attitude of the aircraft.

FIG. 6D illustrates a set of working principles for an aircraft in accordance with an aspect of the present disclosure. An aircraft may optionally have six degrees of freedom. For example, the aircraft may be capable of rotating about three axes of rotation, and for generating a lift force. For example, in a rotorcraft, the rotors may rotate to generate lift of the aircraft. The rotors may rotate to permit the aircraft to rotate about one, two, or three axes of rotation simultaneously. In some instances, the axes of rotation may be orthogonal to one another and/or may remain orthogonal to one another during the flight of the aircraft (e.g., .theta., .phi., .psi.). The axes of rotation may include pitch, yaw, and/or roll axes of rotation.

In some aspects, the rotorcraft may have a plurality of rotors, each capable of generating lift for the rotorcraft (e.g., F₁, F₂, F₃, F₄). In one example, four rotors may be provided. The rotors may generate the same amount or lift or differing amounts of lift. The rotors may rotate with the same angular velocity, or with different angular velocities (e.g., ω₁, ω₂, ω₃, ω₄).

Robust and adaptive control strategy may be useful for a multi-rotor aircraft. The system governing flight of a multi-rotor aircraft may be unstable by nature, and may diverge in seconds if no proper control law is applied. The system may be nonlinear. The nonlinearity of the system and the complexity of aerial dynamics necessitate improvements in controller design.

The systems and methods described herein may model the dynamics of aircraft flight and develop a control scheme to stabilize the attitude of a multi-rotor aircraft, of which the configuration manifold can be nonlinear. The dynamics and proposed control system can be expressed on the special orthogonal group, SO(3), to avoid singularity and ambiguities associated with other attitude representations such as Euler angle and quaternion. Modeling of the multi-rotor aircraft can include kinematics and dynamics analysis of the multi-rotor and system identification of the actuators (e.g., motor, rotor, and/or propeller).

Finite element analysis (FEM) can be used to estimate the moment of inertia of the system. A first order inertia system with time delay may be considered as the approximate model for the system identification. The control system can be broken down into proportional control on SO(3) and cascade PID (proportional, integral and derivative) control of dynamics with feed-forward compensation, as described elsewhere herein. For control on SO(3), the error may be defined as the natural error on SO(3), (may be provided in terms of geodesic, which may be desirable). The proportional control may be defined on an exponential coordinate of SO(3), since it is a linear space. The control scheme can be verified by a Lyapunov function to ensure stability on a nonlinear manifold. For cascade PID control of dynamics, the controller may be organized in sequence of exponential coordinate of SO(3), angular velocity, and angular acceleration. Techniques using an incomplete differential PID controller and Smith predictor may be employed to further suppress the noise and improve the control quality. Furthermore, feed-forward compensation may be added to improve transient response. Further descriptions of control schemes for multi-rotor aircraft are described elsewhere herein.

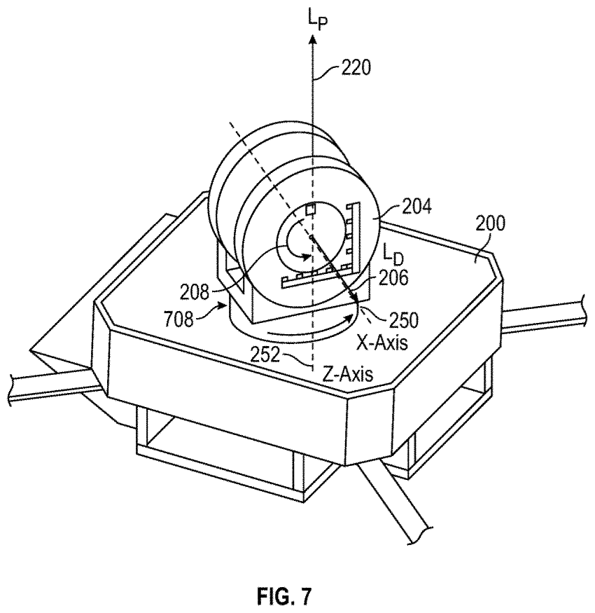

FIG. 7 shows an internal perspective view of Payload 204 of the system according to an aspect of the present disclosure. Payload 204 may have Internal Mechanisms 208 which have oscillatory spinning functionality about an X-Axis 250 relative to Payload 204. Internal Mechanisms 208 may be necessary for Payload 204 to perform its intended function. Internal Mechanisms 208 may include various electrical sensing components such as electromagnets or other sensors, and motive and drive components such as electric motors, gears, shafts, belts, along with the necessary electrical components required for the intended operation. In one non-limiting example, Payload 204 may be LiDAR internal components that generate an electromagnetic field or electromagnetic waves capable of sensing analytically useful information from the environment surrounding UAV 200. Internal Mechanisms 208 may be various electro-mechanical devices and components which give the LiDAR functionality to sense its surroundings and convert this information into an analytically useful signal. Such components may include gyros, servos, motors, electrical components, and various other electro-mechanical parts.

Payload 204 may be driven to rotate about the Z-Axis 252 which is perpendicular relative to Airframe 202. This may be done by Motor 708 capable of rotating Payload 204 about the Z-Axis 252 through the use of various motive assemblies including gear trains, drive shafts, pulleys, or belts. Motor 708 may optionally be any assembly capable transversal or rotational motion with respect to UAV 200. Motor 708 may also include sensors or encoders that are able to determine the angle and/or angular velocity of Payload 204. The sensors or encoders of Motor 708 may be considered part of Plant 510.

The design of Payload 204, including the orientation, nature, and action of its Internal Mechanisms 208 will depend entirely on the intended function and operation. Depending on the configuration of the internal components, angular momentums may be generated in any direction and in many different combinations. If a specific configuration of angular momentums caused by the operation and function of Payload 204's Internal Mechanisms 208 were known, then it is possible to calculate the various angular momentums generated by Payload 204. Such angular momentums may impart a net moment or unbalanced force upon UAV 200 thereby causing it to deflect from a preferred orientation, but can be addressed using the invention of the present disclosure.

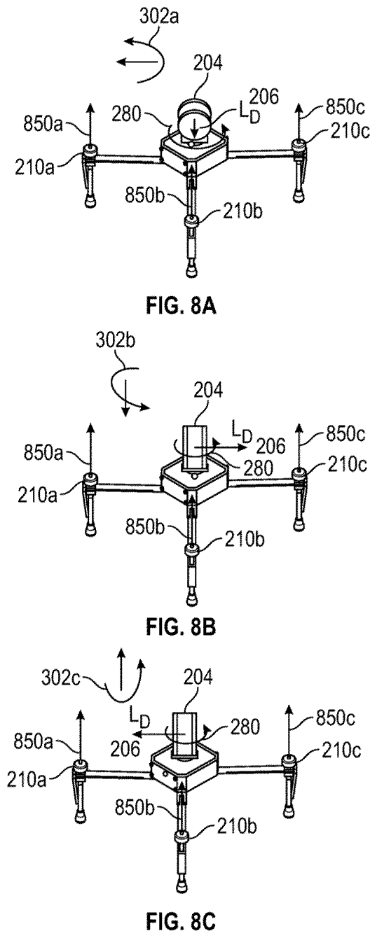

FIG. 8 shows a system without compensation. FIG. 8A shows a system wherein L_{D} 206 points toward Thruster 210b, with Payload 204 rotating counter-clockwise relative to Airframe 202 as depicted by Rotation 280. Thrust Vector Profile 850 may depict the thrust vectors of the Thrusters 210 in response to Net Force/Torque Vector 302a. It should be understood that Thrust Vector Profile 850 is illustrative only, and the lengths of the arrows are not directly proportional to the thrust values. A longer line simply represents a larger thrust without regard to the exact magnitude. In an uncompensated system, Thrust Vector Profile 850 will not adjust to Net Force/Torque Vector 302a until an attitude change is sensed and adjusted for by the aircraft's Position Controller 502. As depicted in the figure, no attitude disturbance has been measured, so the thrust profile of each Thruster 210 is pointing upward at equal amounts to counteract the force of gravity on UAV 200. Net Force/Torque Vector 302a may be oriented towards Thruster 210 without compensation.

FIG. 8B shows a system according to an aspect of the present disclosure wherein L_{D} 206 is pointing towards Thruster 210c, with a Payload 204 rotating counter-clockwise relative to Airframe 202 as depicted by Rotation 280. Thrust Vector Profile 850 may depict the thrust vectors of the Thrusters 210 in response to Net Force/Torque Vector 302b. In an uncompensated system, Thrust Vector Profile 850 will not adjust to Net Force/Torque Vector 302b until an attitude change is sensed and adjusted for by the craft's Attitude Controller 504. As depicted in the figure, no attitude disturbance has been measured so the thrust profile of each Thruster 210 is pointing upwards at equal amounts to counteract the force of gravity on UAV 200. Net Force/Torque Vector 302b may be oriented towards Thruster 210 without compensation.

FIG. 8C shows a system according to an aspect of the present disclosure wherein L_{D} 206 is pointing towards Thruster 210a, with a Payload 204 rotating counter-clockwise relative to Airframe 202 as depicted by Rotation 280. Thrust Vector Profile 850 may depict the thrust vectors of the Thrusters 210 in response to Net Force/Torque Vector 302c. In an uncompensated system, Thrust Vector Profile 850 will not adjust to Net Force/Torque Vector 302c until an attitude change is sensed and adjusted for by the craft's Attitude Controller 504. As depicted in the figure, no attitude disturbance has been measured so the thrust profile of each Thruster 210 is pointing upwards at equal amounts to counteract the force of gravity on UAV 200. Net Force/Torque Vector 302c may be oriented towards Thruster 210 (not pictured in figure because it is hidden in the perspective), or into the page without compensation.

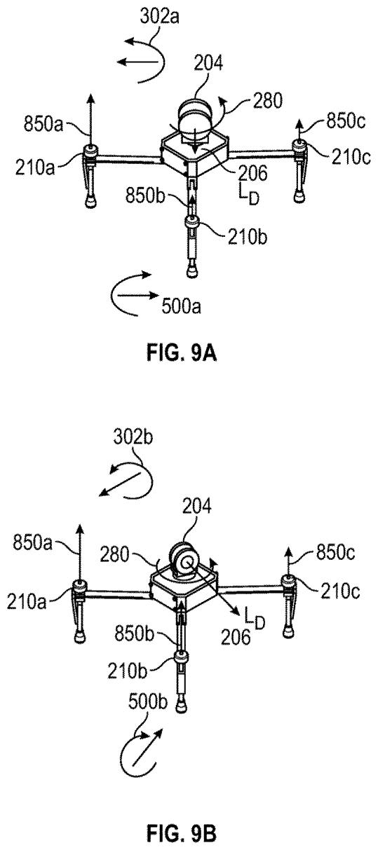

FIG. 9 shows a system with compensation according to an aspect of the present disclosure. FIG. 9A shows a system wherein L_{D} 206 is pointing towards Thruster 210b, with a Payload 204 rotating counter-clockwise relative to Airframe 202 as depicted by Rotation 280. Thrust Vector Profile 850 may depict the thrust vectors of the Thrusters 210 in response to Net Force/Torque Vector 302a. With compensation, the system may calculate and analyze the Net Force/Torque Vector 302a and then calculate a corresponding thrust vector profile necessary to cancel Net Force/Torque Vector 302a. As depicted in FIG. 9A, the thrust vector of each Thruster 210 may be different, with the Thruster 210a capable of exerting a net torque on Airframe 202 capable of cancelling the torque applied by Net Force/Torque Vector 302a producing more thrust than the other Thrusters 210. Thrust Vector Profile 850a depicts a greater amount of thrust from Thruster 210a by showing a larger arrow, relative to Thrusters 210b and 210c. It should be understood that Thrust Vector Profiles 850a-c are illustrative only, and the lengths of the arrows are not directly proportional to the thrust values. A longer line simply represents a larger thrust without regard to the exact magnitude. The increased thrust from Thruster 210c relative to one or more other Thrusters 210 may impart a Net Cancelling Force/Torque 500a on Airframe 202 such that the effect of Net Force/Torque Vector 302a is negated and prevented.

FIG. 9B shows a system with compensation according to an aspect of the present disclosure wherein L_{D} 206 is pointing in between Thrusters 210b and 210c, with a Payload 204 rotating counter-clockwise relative to Airframe 202 as depicted by Rotation 280. Thrust Vector Profile 850b and 850c may depict the thrust vectors of the Thrusters 210b and 210c in response to Net Force/Torque Vector 302b. With compensation, the system may calculate and analyze the Net Force/Torque Vector 302b and the corresponding thrust vector profile necessary to cancel Net Force/Torque Vector 302b. As depicted in FIG. 9B, the thrust vector of each Thruster 210 may be different, with the Thrusters 210b and 210c exerting a net torque on Airframe 202 capable of cancelling the torque applied by Net Force/Torque Vector 302b by producing more thrust than Thruster 210a. Thrust Vector Profile 850b and 850c depicts a greater amount of thrust from the preferred Thrusters 210b and 210c by showing a larger arrow relative to Thrust Vector Profile 850a. It should be understood that Thrust Vector Profiles 850a-c are illustrative only, and the lengths of the arrows are not directly proportional to the thrust values. A longer line simply represents a larger thrust without regard to the exact magnitude. The increased thrust from Thrusters 210b and 210c and decreased thrust from Thruster 210a may impart a Net Cancelling Force/Torque 500b on Airframe 202 such that the effect of Net Force/Torque Vector 302a is negated and prevented.

In the non limiting example of an oscillating Net Force/Torque Vector 302, as Net Force/Torque Vector 302 oscillates or moves around UAV 200, the thrusts of each Thruster 210 can be modulated accordingly to create a Thrust Vector Profile 850 capable of generating a Net Cancelling Force/Torque 500 that also oscillates and moves around UAV 200. When Net Cancelling Force/Torque 500 and Net Force/Torque Vector 302 are in phase, the attitude disturbances created by onboard mechanisms may be able to be eliminated, leading to better operational flight and control of UAV 200.

It should be understood that although the above paragraphs describe compensation for an oscillatory disturbance, the system of the present disclosure may also be used to compensate for non-oscillatory disturbances. As long as the Net Force/Torque Vector 302 imparted by the Payload 204 and/or Internal Mechanisms 208 are able to be analyzed prior to their operation, a Net Cancelling Force/Torque 500 may be able to be calculated corresponding Thrust Vector Profile 850 determined. When Payload 204 and Internal Mechanisms 208 begin their attitude disturbing operation, Thrusters 210 may then execute Thrust Vector Profile 850 such that Net Force/Torque Vector 302 is cancelled by Net Cancelling Force/Torque 500. When Payload 204 and/or Internal Mechanisms 208 stop their attitude disturbing operation, Thrusters 210 may then cease the execution of Thrust Vector Profile 850 and return to normal static or dynamic operation as required by undisturbed flight. The calculations and subsequent conversions to electrical signals capable of modulating thrust provided by Thrusters 210 may be done with the aid of a processor.

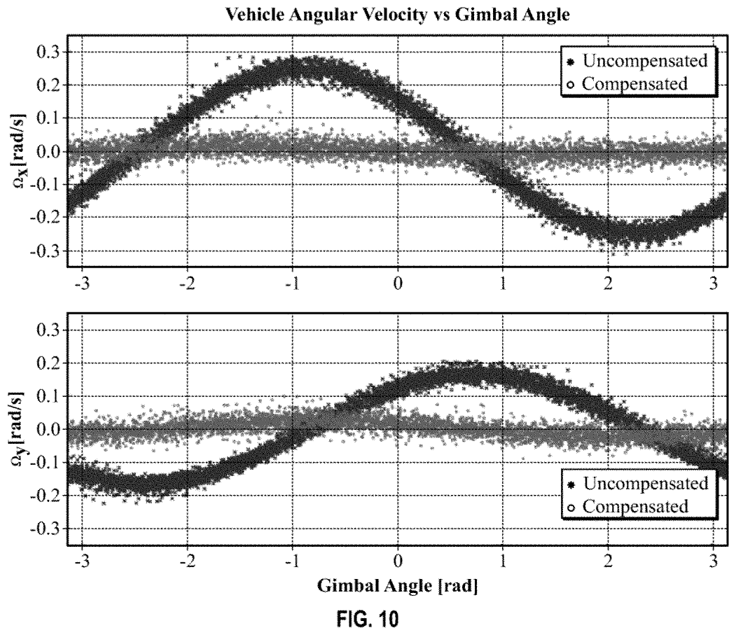

FIG. 10 shows graphs illustrating vehicle angular velocity versus gimbal angle according to an aspect of the present disclosure. The graphs show results comparing autonomous flights with and without compensation of momentum in the rotating device. The horizontal axis is the measured gimbal angle, and the vertical axis is the measured angular velocity of the vehicle. The top graph shows measured angular velocity about the ‘x’ axis. The bottom graph shows measured angular velocity about the ‘y’ axis. Data is taken over 60 seconds of stable flight while uncompensated and over 60 seconds of stable flight while compensated. The data shows a significant reduction in angular velocity of the vehicle when using the compensation method of the present disclosure. These results were taken from an autonomous flight using a gimbal Velodyne VLP-16 mounted on a DJI M210 V2 aerial platform.

What is claimed is:

1. A method for compensating disturbances in an aerial vehicle having a plurality of thrusters, the disturbances caused by a payload rotating about one or more axes and coupled to the aerial vehicle, the method comprising the steps of:
a. determining aerial vehicle parameters;
b. determining payload parameters comprising physical parameters and dynamic parameters;
c. determining a preferred orientation of the aerial vehicle based on the aerial vehicle parameters and operational instructions;
d. determining a corrective input based on aerial vehicle parameters, payload parameters, and actual orientation feedback;
e. determining an operation of one or more of the plurality of thrusters based on the corrective input and the preferred orientation, then controlling an output of one or more of the plurality of thrusters accordingly; and
f. determining an actual orientation of the aerial vehicle and generating the actual orientation feedback.

2. The method of claim 1, wherein the payload rotates about a first axis and the payload includes a mechanism rotating about a second axis orthogonal to the first axis.

3. The method of claim 2, wherein the payload is a LiDAR system.

4. The method of claim 1, wherein aerial vehicle parameters comprise physical parameters comprising one or more of spatial dimensions, morphology, weight-related properties, and material properties.

5. The method of claim 1, wherein aerial vehicle parameters comprise dynamic parameters comprising one or more of electronic specifications, power source specifications, and motor characteristics.

6. The method of claim 1, wherein the thrusters are propellers driven by motors.

7. The method of claim 1, wherein dynamic payload parameters comprise torque generated by single or multi-axis angular momentum created by the payload.
